(19) United States
(12) Patent Application Publication
(10) Pub. No.: US 2025/0210262 A1
(43) Pub. Date: Jun. 26, 2025

(54) MULTILAYER ELECTRONIC COMPONENT

(71) Applicant: SAMSUNG ELECTRO-MECHANICS CO., LTD., Suwon-si (KR)

(72) Inventors: Seung Yeon Lee, Suwon-si (KR); Yong Koo Kim, Suwon-si (KR); Ji Won Kim, Suwon-si (KR); Hyun Min Lim, Suwon-si (KR); Sung Hyung Kang, Suwon-si (KR); Dong Su Cho, Suwon-si (KR)

(73) Assignee: SAMSUNG ELECTRO-MECHANICS CO., LTD., Suwon-si (KR)

(21) Appl. No.: 18/937,964

(22) Filed: Nov. 5, 2024

(30) Foreign Application Priority Data
Dec. 26, 2023 (KR) 10-2023-0191743

(51) Int. Cl. H01G 4/12; H01G 4/012

(52) U.S. Cl. CPC H01G 4/1227; H01G 4/012

(57) ABSTRACT

A multilayer electronic component includes a body including a dielectric layer and internal electrodes and external electrodes arranged on the body, wherein the internal electrodes include oxidized portions arranged at both end portions in a width direction and oxidized and non-oxidized portions arranged in a center of the internal electrodes in the width direction and not oxidized, wherein t2<t1, in which t1 is an average thickness of the non-oxidized portions and t2 is an average thickness of the oxidized portions.

### CROSS-REFERENCE TO RELATED APPLICATION(S)

This application claims benefit of priority to Korean Patent Application No. 10-2023-0191743 filed on Dec. 26, 2023 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type capacitor mounted on the printed circuit boards of various types of electronic products such as imaging devices including liquid crystal displays (LCDs) and plasma display panels (PDPs), computers, smartphones, cell phones, and the like, to allow electricity to be charged therein and discharged therefrom.

Such an MLCC may be used as a component of various electronic devices due to advantages thereof such as compactness, guaranteed high capacitance, and ease of mounting. As various electronic devices such as computers and mobile devices have been reduced in size and increased in power, demand for miniaturization and high capacitance of multilayer ceramic capacitors have been increased.

Meanwhile, if the number of layers is increased for miniaturization and high capacitance of multilayer ceramic capacitors, a step difference may increase due to a difference in the thickness of internal electrodes and dielectric layers. Such a step difference may cause a rapid change in dimensions between a region in which the internal electrodes are disposed and a region in which in which the internal electrodes are not disposed, and thermal stress may be applied due to a difference in thermal expansion coefficients between the internal electrode region and the dielectric layer region during a cooling process after sintering, which may cause cracks or delamination at an end portion of the internal electrodes in a width direction, which is considered to be a factor in degrading reliability of the multilayer ceramic capacitor.

### SUMMARY

An aspect of the present disclosure is to prevent cracks or delamination inside a multilayer electronic component.

Another aspect of the present disclosure is to improve reliability of a multilayer electronic component.

However, various problems to be solved by the present disclosure are not limited to the aforementioned contents, and will be more easily understood in the process of describing specific embodiments of the present disclosure.

According to an aspect of the present disclosure, a multilayer electronic component includes a body including a dielectric layer and internal electrodes and external electrodes arranged on the body, wherein at least one of the internal electrodes includes an oxidized portion arranged at both end portions of the at least one of the internal electrodes in a width direction, and a non-oxidized portion arranged in a center of the at least one of the internal electrodes in the width direction, wherein t2<t1, in which t1 is an average thickness of the non-oxidized portion and t2 is an average thickness of the oxidized portion.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a perspective view schematically illustrating a multilayer electronic component according to an exemplary embodiment in the present disclosure;

FIG. 2 is a schematic perspective view of a stack structure of internal electrodes;

FIG. 3 is a schematic cross-sectional view taken along line I-I′ in FIG. 1;

FIG. 4 is a schematic cross-sectional view taken along line II-II′ in FIG. 1;

FIG. 5 is a schematic enlarged view of region P in FIG. 4; and

FIG. 6 is an image of a cross-section of internal electrodes according to an exemplary embodiment in the present disclosure captured with a scanning electron microscope (SEM).

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thicknesses of layers, films, panels, regions, etc., may be exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, a first direction may be defined as a stacking direction or thickness (T) direction, a second direction may be defined as a length (L) direction, and a third direction may be defined as a width (W) direction.

### Multilayer Electronic Component

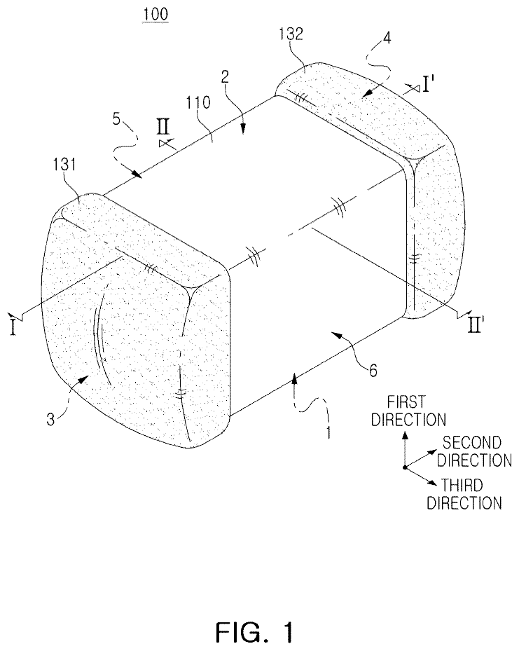

FIG. 1 is a perspective view schematically illustrating a multilayer electronic component according to an exemplary embodiment in the present disclosure.

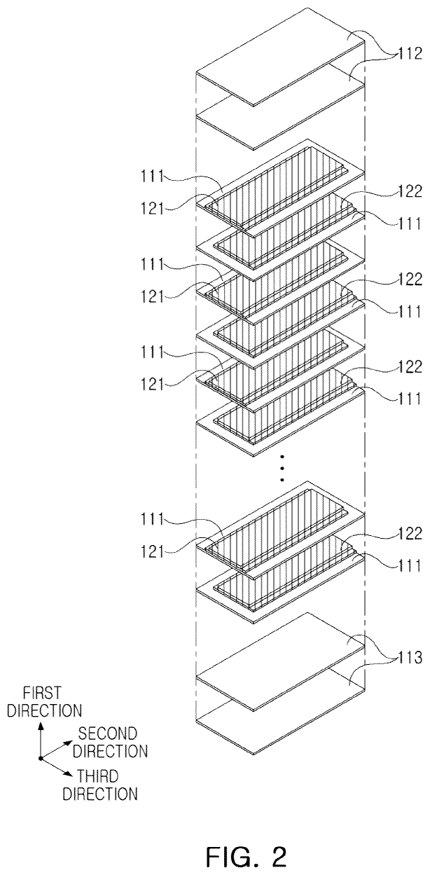

FIG. 2 is a schematic perspective view illustrating an exploded view illustrating a stack structure of internal electrodes.

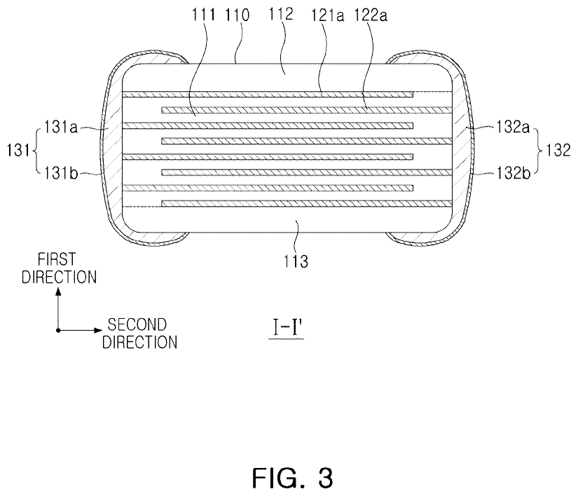

FIG. 3 is a schematic cross-sectional view taken along line I-I′ in FIG. 1.

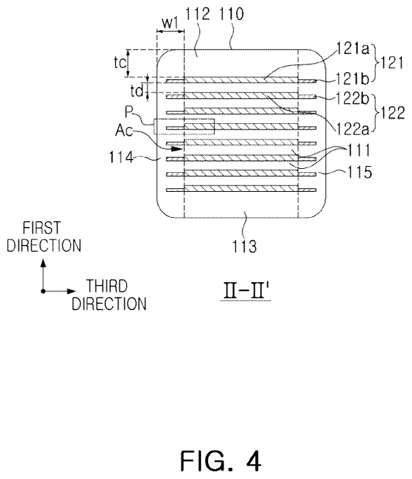

FIG. 4 is a schematic cross-sectional view taken along line II-II′ in FIG. 1.

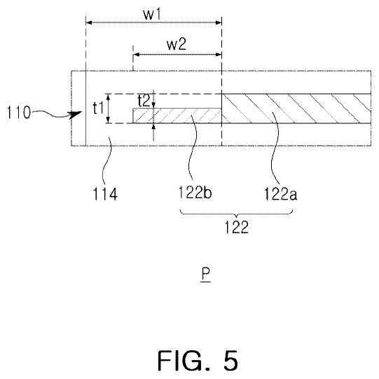

FIG. 5 is a schematic enlarged view of region P in FIG. 4.

Hereinafter, a multilayer electronic component according to an exemplary embodiment in the present disclosure will be described in detail with reference to FIGS. 1 to 5. However, although a multilayer ceramic capacitor is described as an example of a multilayer electronic component, the present disclosure may also be applied to various electronic products using dielectric compositions, such as inductors, piezoelectric elements, varistors, or thermistors.

A multilayer electronic component 100 according to an exemplary embodiment in the present disclosure may include a body 110 including a dielectric layer 111 and internal electrodes 121 and 122 and external electrodes 131 and 132 arranged on the body 110, wherein the internal electrodes 121 and 122 include oxidized portions 121b and 122b arranged at both end portions in the width direction and oxidized and non-oxidized portions 121a and 122a arranged in the center of the internal electrodes in the width direction and not oxidized, wherein t2<t1, in which t1 is an average thickness of the non-oxidized portions 121a and 122a and t2 is an average thickness of the oxidized portions 121b and 122b.

In the body 110, the dielectric layers 111 and the internal electrodes 121 and 122 are alternately stacked.

More specifically, the body 110 may include the first internal electrodes 121 and second internal electrodes 122 disposed inside the body and alternately arranged to face each other with the dielectric layer 111 therebetween to include a capacitance formation portion Ac forming capacitance. Here, the first and second internal electrodes 121 and 122 of the capacitance formation portion Ac forming the capacitance may refer to the non-oxidized portions 121a and 122a described below, and the oxidized portions 121b and 122b may not contribute to forming capacitance.

Although a specific shape of the body 110 is not particularly limited, as shown, the body 110 may have a hexahedral shape or a shape similar thereto. Due to the shrinkage of ceramic powder particles included in the body 110 during a sintering process, the body 110 may not have a perfectly straight hexahedral shape but may have a substantially hexahedral shape.

The body 110 may have first and second surfaces 1 and 2 facing each other in the first direction, third and fourth surfaces connected to the first and second surfaces 1 and 2 and facing each other in the second direction, and fifth and sixth surfaces connected to the first to fourth surfaces 1, 2, 3, and 4 and facing each other in the third direction.

The plurality of dielectric layers 111 forming the body 110 are in a sintered state, and adjacent dielectric layers 111 may be integrated such that boundaries therebetween may not be readily apparent without using a scanning electron microscope (SEM).

A material for forming the dielectric layer 111 is not limited as long as sufficient electrostatic capacitance may be obtained. In general, perovskite (ABO₃)-based materials may be used, and for example, a barium titanate-based material, a lead composite perovskite-based material, or a strontium titanate-based material may be used. The barium titanate-based material may include a BaTiO₃-based ceramic powder particles, and the ceramic powder particles may include BaTiO₃ and (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba (Ti_{1-y}Zr_{y})O₃ (0<y<1) in which Ca, Zr, and the like are partially dissolved in BaTiO₃.

In addition, as a material for forming the dielectric layer 111, various ceramic additives, organic solvents, binders, dispersants, etc. may be added to powder particles, such as barium titanate (BaTiO₃), according to purposes of the present disclosure.

A thickness td of the dielectric layer 111 may not be particularly limited.

However, in order to more easily achieve miniaturization and high capacitance of the multilayer electronic component, the thickness of the dielectric layer 111 may be 3.0 μm or less, preferably 2.0 μm or less, 1.0 μm or less, or 0.6 μm or less, and more preferably 0.4 μm or less.

Here, the thickness td of the dielectric layer 111 may refer to the thickness td of the dielectric layer 111 disposed between the first and second internal electrodes 121 and 122, and more specifically, the thickness td of the dielectric layer 111 disposed between the non-oxidized portions 121a and 122a of the first and second internal electrodes.

Meanwhile, the thickness td of the dielectric layer 111 may refer to the size of the dielectric layer 111 in the first direction. In addition, the thickness td of the dielectric layer 111 may refer to an average thickness td of the dielectric layer 111 and an average size of the dielectric layer 111 in the first direction.

The average size of the dielectric layer 111 in the first direction may be measured by scanning images of cross-sections of the body 110 in the first and second directions with a scanning electron microscope (SEM) at 10,000× magnification. More specifically, the average size of one dielectric layer 111 in the first direction may refer to an average value calculated by measuring the size of one dielectric layer 111 in the first direction at 10 equally spaced points in the second direction in the scanned image. The 10 equally spaced points may be designated in the capacitance formation portion Ac. In addition, if this average value measurement is expanded to ten dielectric layers 111 to measure the average value, the average size of the dielectric layers 111 in the first direction may be further generalized.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately arranged to surface each other with the dielectric layer 111 constituting the body 110 therebetween and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. A first external electrode 131 may be disposed on the third surface 3 of the body 110 and connected to the first internal electrode 121, and a second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Here, the first and second internal electrodes 121 and 122 may be electrically separated from each other by the dielectric layer 111 disposed therebetween.

Meanwhile, the body 110 may be formed by alternately stacking a first ceramic green sheet on which the first internal electrode 121 is printed and a second ceramic green sheet on which the second internal electrode 122 are printed, and then sintering the same.

A material forming the internal electrodes 121 and 122 is not particularly limited, and any material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. The printing method for the conductive paste for internal electrodes may be a screen-printing method or a gravure printing method, but the present disclosure is not limited thereto.

Meanwhile, according to an exemplary embodiment in the present disclosure, the internal electrodes 121 and 122 includes the oxidized portions 121b and 122b arranged at both ends in the width direction and non-oxidized portions 121a and 122a arranged in the center of the internal electrodes in the width direction and not oxidized, wherein t2<t1 in which t1 is an average thickness of the non-oxidized portions 121a and 122a and t2 is an average thickness of the oxidized portions 121b and 122b.

In general, in accordance with the trend of miniaturization of multilayer electronic components, thinning and multilayering of dielectric layers and internal electrodes have been attempted in various manners, and recently, multilayer electronic components in which the thickness of the dielectric layers is thinned while the number of layers is increased have been manufactured.

When the thickness of the dielectric layer decreases and the number of layers increases, a flow amount of a dielectric material in a region in which the internal electrode does not exist, a longitudinal margin region, which is a non-capacitance forming region existing in alternating layers, or a widthwise margin region of the capacitance forming region may decrease and the density may decrease within the ceramic body during a pressing process.

As a result, a significant step portion may occur between the longitudinal or widthwise margin regions of the capacitance forming region, which may cause defects, such as vertical cracks, at the longitudinal or widthwise end portions of the internal electrodes.

In addition, delamination or cracking may occur after sintering, which may result in a degradation in the reliability of the multilayer electronic component.

However, according to an exemplary embodiment in the present disclosure, since the oxidized portions 121b and 122b, which are oxidized regions, are arranged at both end portions of the internal electrodes 121 and 122 in the width direction and the non-oxidized portions 121a and 122a, which are non-oxidized regions, are arranged in the center of the internal electrodes 121 and 122 forming the capacitance in the width direction, it is possible to prevent the occurrence of defects, such as vertical cracks, at the end portions of the internal electrodes 121 and 122 in the width direction or to prevent the occurrence of delamination or cracks after sintering, thereby improving the reliability of the multilayer electronic component 100.

By arranging the oxidized portions 121b and 122b at the widthwise margin portions of the non-oxidized portions 121a and 122a, which are the capacitance formation portions Ac, it is possible to minimize a step portion, i.e., a thickness difference, between the capacitance formation portion Ac and the widthwise margin portion.

This may reduce the occurrence of vertical cracks or delamination, thereby further improving the reliability of the multilayer electronic component 100.

In addition, since the both widthwise end portions of the internal electrodes 121 and 122 are formed as the oxidized portions 121b and 122b, high interfacial bonding force between the oxidized portions 121b and 122b in contact with the dielectric layer 111, an oxide after sintering, may increase the resistance to cracking defect and improve the hardness of the side margin portions 114 and 115, which are widthwise margins of the capacitance formation portion Ac, thereby improving the mechanical properties of the multilayer electronic component 100.

In the present disclosure, a method of dividing the non-oxidized portions 121a and 122a and the oxidized portions 121b and 122b may be, for example, as follows, but is not particularly limited thereto.

When the internal electrode 121 and 122 metal is nickel (Ni), the oxidized portions 121b and 122b may be darker in color than the non-oxidized portions 121a and 122a, and more specifically, the non-oxidized portions 121a and 122a may be white or grayish white, and the oxidized portions 121b and 122b may be black or gray.

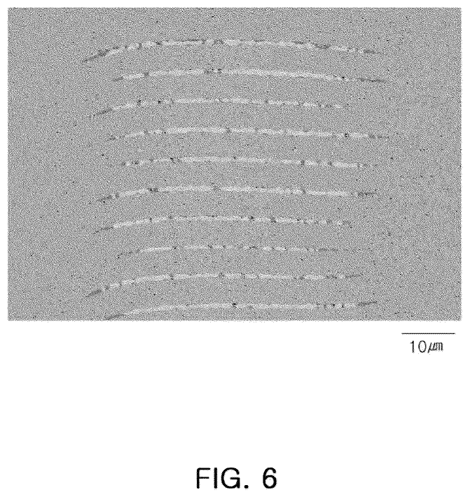

This is described in more detail by taking, as an example, FIG. 6, which is an image of the internal electrodes in the cross-section of the body in the first and third directions according to an exemplary embodiment in the present disclosure observed using a scanning electron microscope (SEM). Imaging conditions of the SEM were a magnification of 3.28 k, a working distance (WD) of 7.2 mm, a brightness of 47.9%, and a contrast of 56.6%. When observed under the conditions, it may be confirmed that the oxidized portions arranged at both widthwise end portions of the internal electrodes are observed as a relatively dark gray (black) and the non-oxidized portions arranged at the widthwise center of the internal electrodes are observed as a relatively bright gray-white (white).

Another method for dividing the non-oxidized portions 121a and 122a and the oxidized portions 121b and 122b is to measure an oxygen content in an energy dispersive X-ray spectroscopy (EDS) mode of a scanning electron microscope (SEM), a transmission electron microscope (TEM), or a scanning transmission electron microscope (STEM).

More specifically, for example, an average atomic percentage (at %) of oxygen included in the oxidized portions 121b and 122b may be higher than an average atomic percentage (at %) of oxygen included in the non-oxidized portions 121a and 122a, and preferably, the ratio of 0 (at %)/Ni (at %) based on the atomic percentage (at %) may be 1.1 or more and 1.5 or less, more preferably 1.17 or more and 1.48 or less, but is not particularly limited thereto.

A method of forming the non-oxidized portions 121a and 122a and the oxidized portions 121b and 122b in the internal electrodes 121 and 122 may be, for example, as follows, but is not particularly limited thereto. First, a first internal electrode pattern having a width smaller than a width of the ceramic green sheet is formed in the widthwise center of a ceramic green sheet, and then a second internal electrode pattern having a width smaller than the width of the first internal electrode pattern is formed in the widthwise center of the first internal electrode pattern. The ceramic green sheets on which the second internal electrode pattern in this manner, is formed are stacked and pressed, and then cut to have a bar size to prepare a stacked bar, and sintering is performed thereon. When sintering is performed, sintering is performed until the second internal electrode pattern is oxidized based on the width direction, so that both widthwise end portions of the first internal electrode pattern arranged on the widthwise outer side of the second internal electrode pattern may be oxidized. Accordingly, the both widthwise end portions of the first internal electrode pattern may become oxidized portions 121b and 122b, and the widthwise center of the first internal electrode pattern and the second internal electrode pattern may become non-oxidized portions 121a and 122a.

In other words, the oxidized portions 121b and 122b and the non-oxidized portions 121a and 122a may be arranged to be in contact with each other.

Since the oxidized portions 121b and 122b and the non-oxidized portions 121a and 122a are arranged to be in contact with each other, the bonding force between the capacitance formation portion Ac and the side margin portions 114 and 115 may be excellent, and the interfacial bonding force between the oxidized portions 121b and 122b and the dielectric material of the side margin portions 114 and 115 may be further improved.

Meanwhile, as described above, as the first internal electrode pattern and the second internal electrode pattern are formed, a thickness of the non-oxidized portions 121a and 122a may be greater than a thickness of the oxidized portions 121b and 122b in a region in which the oxidized portions 121b and 122b and the non-oxidized portions 121a and 122a are in contact with each other.

Since the thickness of the non-oxidized portions 121a and 122a is greater than the thickness of the oxidized portions 121b and 122b in the region in which the oxidized portions 121b and 122b and the non-oxidized portions 121a and 122a are in contact with each other, the bonding force between the capacitance formation portion Ac and the side margin portions 114 and 115 may be excellent.

If the thickness of the non-oxidized portions 121a and 122a is equal to or less than the thickness of the oxidized portions 121b and 122b in the region in which the oxidized portions 121b and 122b and the non-oxidized portions 121a and 122a are in contact with each other, the oxidized portions 121b and 122b may not be sufficiently oxidized.

As described above, by forming the first internal electrode pattern and the second internal electrode pattern, when the average thickness of the non-oxidized portions 121a and 122a is t1 and the average thickness of the oxidized portions 121b and 122b is t2, t2<t1 may be satisfied.

Since the average thickness t1 of the non-oxidized portions 121a and 122a is greater than the average thickness t2 of the oxidized portions 121b and 122b (t2<t1), a step portion between the capacitance formation portion Ac and the side margin portions 114 and 115 may be minimized and the bonding force may be improved to prevent cracks or delamination defects.

Meanwhile, if the average thickness t1 of the non-oxidized portions 121a and 122a is equal to or less than the average thickness t2 of the oxidized portions 121b and 122b (t1≤t2), the oxidized portions 121b and 122b may not be sufficiently oxidized and interfacial bonding force between the oxidized portions 121b and 122b and the side margin portions 114 and 115 may not be sufficiently strengthened, which may cause cracks or delamination.

A method for measuring the average thickness t1 of the non-oxidized portions 121a and 122a and the average thickness t2 of the oxidized portions 121b and 122b is as follows: for example, in a cross-section in the first and third directions of the body 110 at the center of the body 110 in the second direction, observed by a scanning electron microscope (SEM), an average value calculated by measuring sizes in the first direction at five equally spaced points in the third direction in one of the non-oxidized portions 121a and 122a may be referred to as an average thickness t1 of the non-oxidized portions 121a and 122a, and an average value calculated by measuring the sizes in the first direction at three equally spaced points in the third direction in one of the oxidized portions 121b and 122b disposed at both widthwise end portions of the non-oxidized portions 121a and 122a may be referred to as an average thickness t2 of the oxidized portions 121b and 122b. Other methods and/or tools appreciated by one of ordinary skill in the art, even if not described in the present disclosure, may also be used. The thickness of the non-oxidized portion 121a and the oxidized portion 121b in a region in which the oxidized portion 121b and the non-oxidized portion 121a contact each other may be observed by a scanning electron microscope (SEM) or other methods and/or tools appreciated by one of ordinary skill in the art, even if not described in the present disclosure.

The average thickness t1 of the non-oxidized portions 121a and 122a and the average thickness t2 of the oxidized portions 121b and 122b may satisfy 0.05≤t2/t1≤0.65, and preferably, 0.20≤t2/t1≤0.62.

Since the average thickness t1 of the non-oxidized portions 121a and 122a and the average thickness t2 of the oxidized portions 121b and 122b satisfy 0.05≤t2/t1≤0.65, a step portion between the capacitance formation portion Ac and the side margin portions 114 and 115 may be minimized and the bonding force may be improved to prevent cracks or delamination defects.

Meanwhile, if t2/t1 is less than 0.05, it may be difficult to minimize the step portion between the capacitance formation portion Ac and the side margin portions 114 and 115, and thus, the bonding force may not be improved and cracks or delamination may occur. In addition, if t2/t1 exceeds 0.65, the oxidized portions 121b and 122b may not be sufficiently oxidized, and thus, the interfacial bonding force between the oxidized portions 121b and 122b and the side margin portions 114 and 115 may not be sufficiently strengthened and cracks or delamination may occur.

Meanwhile, the average thickness t1 of the non-oxidized portions 121a and 122a may not be particularly limited.

However, in order to more easily achieve miniaturization and high capacitance of the multilayer electronic component, an upper limit of the average thickness t1 of the non-oxidized portions 121a and 122a may be 2.0 μm or less, preferably 1.0 μm or less, or 0.6 μm or less, more preferably 0.4 μm or less, and a lower limit thereof may be 0.3 μm or more.

In addition, the average thickness t2 of the oxidized portions 121b and 122b may not be particularly limited.

However, in order to more easily achieve miniaturization and high capacitance of the multilayer electronic component and improve the bonding force between the capacitance formation portion Ac and the side margin portions 114 and 115, an upper limit of the average thickness t2 of the oxidized portions 121b and 122b may be 1.0 μm or less, and a lower limit thereof may be 0.2 μm or more.

Meanwhile, the body 110 may include cover portions 112 and 113 disposed on both end-surfaces of the capacitance formation portion Ac in the first direction.

Specifically, the body 110 may include a first cover portion 112 disposed on one surface of the capacitance formation portion Ac in the first direction and a second cover portion 113 disposed on the other surface of the capacitance formation portion Ac in the first direction, and more specifically, the body 110 may include an upper cover portion 112 disposed above the capacitance formation portion Ac in the first direction and a lower cover portion 113 disposed below the capacitance formation portion Ac in the first direction.

The upper cover portion 112 and the lower cover portion 113 may be formed by stacking a single dielectric layer 111 or two or more dielectric layers 111 on upper and lower surfaces of the capacitance formation portion Ac in the first direction, respectively, and may serve to prevent damage to the internal electrodes 121 and 122 due to physical or chemical stress.

The upper cover portion 112 and the lower cover portion 113 may not include the internal electrodes 121 and 122 and may include the same material as that of the dielectric layer 111. That is, the upper cover portion 112 and the lower cover portion 113 may include a ceramic material, for example, a barium titanate (BaTiO₃)-based ceramic material.

Meanwhile, the thickness tc of the cover portions 112 and 113 may not be particularly limited.

However, in order to more easily achieve miniaturization and high capacitance of multilayer electronic components, the thickness tc of the cover portions 112 and 113 may be 100 μm or less, preferably, 30 μm or less, and more preferably, 20 μm or less, as ultra-small products.

Here, the thickness tc of the cover portions 112 and 113 may refer to the size of the cover portions 112 and 113 in the first direction. In addition, the thickness tc of the cover portions 112 and 113 may refer to an average thickness tc of the cover portions 112 and 113 and may refer to an average size of the cover portions 112 and 113 in the first direction.

The average size of the cover portions 112 and 113 in the first direction may be measured by scanning images of the cross-sections of the body 110 in the first and second directions with a scanning electron microscope (SEM) at 10,000 magnification. More specifically, the average size of the cover portions 112 and 113 may be an average value calculated by measuring the size in the first direction at 10 points at equal intervals in the second direction in a scanned image of one cover portion.

In addition, the average size of the cover portion 112 in the first direction measured by the aforementioned method may be substantially equal to the average size of the cover portion in the first direction in the cross-sections of the body 110 in the first and third directions.

Meanwhile, based on the third direction, a region between the non-oxidized portions 121a and 122a and the body 110 may be referred to as the side margin portions 114 and 115.

More specifically, the side margin portions 114 and 115 may include a first side margin portion 114 which is a region from one end portion of the non-oxidized portions 121a and 122a in the third direction to an adjacent widthwise surface of the body 110 and a second side margin portion 115 which is a region from the other end portion of the non-oxidized portions 121a and 122a in the third direction to the adjacent widthwise surface of the body 110.

In other words, the side margin portions 114 and 115 may include the first side margin portion 114 which is a region from a left end portion of the non-oxidized portions 121a and 122a in the third direction to the fifth surface 5 of the body 110 and the second side margin portion 115 which is a region from a right end portion of the non-oxidized portions 121a and 122a in the third direction to the sixth surface 6 of the body.

That is, the side margin portions 114 and 115 may be arranged on both end surfaces of the capacitance formation portion Ac in the third direction.

The side margin portions 114 and 115 may refer to a region between both end portions of the non-oxidized portions 121a and 122a in the third direction and a boundary surface of the body 110, based on the cross-section of the body 110 in the first and third directions, as illustrated.

The side margin portions 114 and 115 may basically serve to prevent damage to the non-oxidized portions 121a and 122a due to physical or chemical stress.

The side margin portions 114 and 115 may refer to a region in which the non-oxidized portions 121a and 122a are not formed after the non-oxidized portions 121a and 122a are formed by applying a conductive paste for internal electrodes to a ceramic green sheet.

Meanwhile, in order to suppress a step portion by the internal electrode 121 and 122, the side margin portions 114 and 115 may include the oxidized portions 121b and 122b.

Meanwhile, a width w1 of the first and second side margin portions 114 and 115 may not be particularly limited.

However, in order to more easily achieve miniaturization and high capacitance of the multilayer electronic component 100, an upper limit value of the width w1 of the first and second side margin portions 114 and 115 may be 150 μm or less, a lower limit value thereof may be 120 μm or more, and in ultra-small products, the upper limit value may be 30 μm or less, more preferably 20 μm or less, and the lower limit value may be 5 μm or more, more preferably 10 μm or more.

Here, the width w1 of the side margin portions 114 and 115 may refer to a size of each of the side margin portions 114 and 115 in the third direction. In addition, the width w1 of the side margin portions 114 and 115 may refer to an average width w1 of the side margin portions 114 and 115 and may refer to an average size of the side margin portions 114 and 115 in the third direction.

The average size of the side margin portions 114 and 115 in the third direction may be measured by scanning images of the first and third direction cross-sections of the body 110 with a scanning electron microscope (SEM) at 10,000 magnification. More specifically, the average size may refer to an average value calculated by measuring the size in the third direction at 10 points at equal intervals in the first direction in a scanned image of one side margin portion. Other methods and/or tools appreciated by one of ordinary skill in the art, even if not described in the present disclosure, may also be used.

This may be equally applied to a method of measuring an average width w2 of the oxidized portions 121b and 122b described below.

Meanwhile, in an exemplary embodiment in the present disclosure, the average width w1 from one end portion of the non-oxidized portions 121a and 122a in the width direction to the adjacent widthwise surface of the body 110 and the average width w2 of the oxidized portions 121b and 122b arranged at one end portion of the internal electrode in the width direction may satisfy w2<w1.

Here, the average width w1 from one end portion of the non-oxidized portions 121a and 122a in the width direction to the adjacent widthwise surface of the body 110 may refer to the average width w1 of one side margin portions 114 and 115, and the average width w2 of the oxidized portions 121b and 122b arranged at one end portion of the internal electrode in the width direction may refer to the average width w2 of one oxidized portions 121b and 122b.

Since the average width w1 of the side margin portions 114 and 115 is wider than the average width w2 of the oxidized portions 121b and 122b (w2<w1), the oxidized portions 121b and 122b may be arranged to be apart from the widthwise surface of the body 110 and the internal electrodes 121 and 122 may not protrude to the outside of the body 110.

More specifically, the average width w1 from one end portion of the non-oxidized portions 121a and 122a in the width direction to the adjacent widthwise surface of the body 110 and the average width w2 of the oxidized portions 121b and 122b arranged at one end portion of the internal electrode in the width direction may satisfy 0.3≤w2/w1≤0.6, and more preferably 0.37≤w2/w1≤0.53.

Since the average width w1 from one end portion of the non-oxidized portions 121a and 122a in the width direction to the adjacent widthwise surface of the body 110 and the average width w2 of the oxidized portions 121b and 122b arranged at one end portion of the internal electrode in the width direction satisfy 0.3≤w2/w1≤0.6, the interfacial bonding force between the oxidized portions 121b and 122b and the side margin portions 114 and 115 may be improved, so that cracks or delamination may not occur.

If the average width w1 from one end portion of the non-oxidized portions 121a and 122a in the width direction to the adjacent widthwise surface of the body 110 and the average width w2 of the oxidized portions 121b and 122b arranged at one end portion of the internal electrode in the width direction is w2/w1<0.3, the interfacial bonding force may not be sufficiently strengthened, which may cause cracks or delamination, and if the average width w1 from one end portion of the non-oxidized portions 121a and 122a in the width direction to the adjacent widthwise surface of the body 110 and the average width w2 of the oxidized portions 121b and 122b arranged at one end portion of the internal electrode in the width direction is 0.6<w2/w1, the oxidized portions 121b and 122b may not be sufficiently oxidized and the interfacial bonding force between the oxidized portions 121b and 122b and the side margin portions 114 and 115 may not be sufficiently strengthened to cause cracks or delamination.

The average width w2 of the oxidized portions 121b and 122b is not particularly limited.

However, in order to more easily achieve miniaturization and high capacitance of the multilayer electronic component, an upper limit of the average width w2 of the oxidized portions 121b and 122b may be 100 μm or less, preferably 80 μm or less, and a lower limit thereof may be 30 μm or more, preferably 40 μm or more.

In addition, in an exemplary embodiment in the present disclosure, the oxidized portions 121b and 122b may not be substantially bent.

The widthwise end portion of the internal electrode may be bent due to a step portion during pressing as the number of layers increases, but the oxidized portions 121b and 122b arranged at the widthwise end portion of the internal electrode of the present disclosure may not be substantially bent.

Since the oxidized portions 121b and 122b is not substantially bent, the interfacial bonding force between the internal electrode 121 and 122 and the side margin portions 114 and 115 may be further improved.

Here, the oxidized portions 121b and 122b being substantially not bent means that, when observing the cross-section of the body 110 in the first and third directions based on the center of the body 110 in the second direction, an angle between a first extension line, which is an extension line from the center of the non-oxidized portions 121a and 122a in the first direction toward the second direction and a second extension line, which is an extension line from the center of the oxidized portions 121b and 122b in the first direction toward the second direction is 10° or less, more preferably 5° or less, but is not particularly limited thereto.

In an exemplary embodiment in the present disclosure, a structure in which the ceramic electronic component 100 has two external electrodes 131 and 132 is described, but the number and shape of the external electrodes 131 and 132 may vary according to the shape of the internal electrodes 121 and 122 or other purposes.

The external electrodes 131 and 132 may be disposed on the body 110 and connected to the internal electrodes 121 and 122.

More specifically, the external electrodes 131 and 132 may include first and second external electrodes 131 and 132 disposed on the third and fourth surfaces 3 and 4 of the body 110 and connected to the first and second internal electrodes 121 and 122, respectively. That is, the first external electrode 131 may be disposed on the third surface 3 of the body and connected to the first internal electrode 121, and the second external electrode 132 may be disposed on the fourth surface 4 of the body and connected to the second internal electrode 122.

In addition, the external electrodes 131 and 132 may extend to be disposed in a portion of the first and surfaces 1 and 2 of the body 110 or may extend to be disposed in a portion of the fifth and sixth surfaces 5 and 6 of the body 110. That is, the first external electrode 131 may be disposed on portions of the first, second, fifth, and sixth surfaces 1, 2, 5, and 6 of the body 110 and on the third surface 3 of the body 110, and the second external electrode 132 may be disposed on portions of the first, second, fifth, and sixth surfaces 1, 2, 5, and 6 of the body 110 and on the third surface 3 of the body 110.

The external electrodes 131 and 132 may be formed using any material that has electrical conductivity, such as metal, and the specific material may be determined by considering electrical characteristics, structural stability, etc., and may further have a multilayer structure.

For example, the external electrode 131 and 132 may include an electrode layer 131a and 132a disposed on the body 110 and a plating layer 131b and 132b disposed on the electrode layer 131a and 132a.

For a more specific example of the electrode layer 131a and 132a, the electrode layer 131a and 132a may be a sintered electrode including a conductive metal and glass or a resin-based electrode including a conductive metal and resin.

In addition, the electrode layer 131a and 132a may be in a form in which a sintered electrode and a resin-based electrode are sequentially formed on the body 110.

In addition, the electrode layers 131a and 132a may be formed by transferring a sheet including a conductive metal onto the body 110 or by transferring a sheet including a conductive metal onto a sintered electrode.

The conductive metal used in the electrode layers 131a and 132a is not particularly limited as long as it is a material that may be electrically connected to the internal electrodes 121 and 122 to form capacitance, and may include, for example, one or more selected from the group consisting of nickel (Ni) and copper (Cu), palladium (Pd), silver (Ag), gold (Au), platinum (Pt), tin (Sn), tungsten (W), titanium (Ti), and alloys thereof. The electrode layers 131a and 132a may be formed by applying a conductive paste prepared by adding glass frit to the conductive metal powder particles and then sintering the same.

The plating layer 131b and 132b may serve to improve the mounting characteristics.

The type of the plating layer 131b and 132b is not particularly limited and may be a single plating layer 131b and 132b including one or more of nickel (Ni), tin (Sn), silver (Ag), palladium (Pd), and alloys thereof or may be formed of multiple layers.

For a more specific example of the plating layers 131b and 132b, the plating layers 131b and 132b may be Ni plating layers or Sn plating layers, and the Ni plating layer and Sn plating layer may be sequentially formed on the electrode layers 131a and 132a, or a Sn plating layer, a Ni plating layer, and a Sn plating layer may be formed sequentially. In addition, the plating layers 131b and 132b may include a plurality of Ni plating layers and/or a plurality of Sn plating layers.

The size of the multilayer electronic component 100 may not be particularly limited.

However, in order to achieve miniaturization and high capacitance at the same time, the thickness of the dielectric layer and the internal electrode should be thinned to increase the number of layers, so the effect according to the present disclosure may be more remarkable in the multilayer electronic component 100 having the size of 1005 (length×width: 1.0 mm×0.5 mm, an error range of the length and width is within ±5%) or less or the size of 0603 (length×width: 0.6 mm×0.3 mm, an error range of the length and width is within ±5%) or less. The length and width of the multilayer electronic component 100 may be measured using an optical microscope. Other methods and/or tools appreciated by one of ordinary skill in the art, even if not described in the present disclosure, may also be used.

Hereinafter, the present disclosure is described in more detail through examples, but this is to help a specific understanding of the present disclosure, and the scope of the present disclosure is not limited by the examples.

### Example

A first first internal electrode pattern was printed on a first ceramic green sheet and a second first internal electrode pattern was printed on the first first internal electrode pattern to form a first internal electrode, a first second internal electrode pattern was printed on the second ceramic green sheet and a second second internal electrode pattern was printed on the first second internal electrode pattern to form a second internal electrode, and then the first and second internal electrodes were repeatedly stacked and sintered to produce a sample.

At this time, the sintering was controlled so that the end portions of the internal electrodes were oxidized, and regions in which both end portions of the internal electrode in the width direction were oxidized were designated as oxidized portions, and a region in the center of the internal electrode in the width direction, which was not oxidized, was designated as a non-oxidized portion.

In [Table 1], t1 refers to an average thickness of the non-oxidized portion, t2 refers to an average thickness of the oxidized portion, the ratio of t2/t1 was calculated and described, and the units of t1 and t2 are μm.

Also, in [Table 2], w1 refers to an average width of a side margin portion, w2 refers to an average width of the oxidized portion, the ratio of w2/w1 is calculated and described, and the units of w1 and w2 are μm.

TABLE 1

| Sample | t1 (μm) | t2 (μm) | t2/t1 |
|---|---|---|---|
| 1 | 1.232 | 0.274 | 0.22 |
| 2 | 1.506 | 0.411 | 0.27 |
| 3 | 1.506 | 0.306 | 0.20 |
| 4 | 1.104 | 0.493 | 0.45 |
| 5 | 1.232 | 0.564 | 0.46 |
| 6 | 1.648 | 0.612 | 0.37 |
| 7 | 1.512 | 0.411 | 0.27 |
| 8 | 1.648 | 0.564 | 0.34 |
| 9 | 1.376 | 0.564 | 0.41 |
| 10 | 1.506 | 0.612 | 0.41 |
| 11 | 1.127 | 0.700 | 0.62 |
| 12 | 1.665 | 0.876 | 0.53 |

When the cross-section in the first and third directions was observed from the center of Sample 1 to Sample 12 in the second direction, no samples with cracks or delamination were found.

From this, it can be seen that, when 0.20≤t2/t1≤0.62 is satisfied, the bonding force between the capacitance formation portion and the side margin portion may be improved, thereby improving the strength characteristics.

TABLE 2

| Sample | w1 (μm) | w2 (μm) | w2/w1 |
|---|---|---|---|
| 13 | 141.01 | 56.37 | 0.40 |
| 14 | 128.65 | 67.56 | 0.53 |
| 15 | 149.69 | 54.82 | 0.37 |
| 16 | 144.62 | 66.19 | 0.46 |
| 17 | 120.17 | 45.39 | 0.38 |
| 18 | 126.80 | 55.19 | 0.44 |
| 19 | 120.17 | 59.5 | 0.50 |
| 20 | 120.17 | 47.39 | 0.39 |
| 21 | 127.35 | 66.56 | 0.52 |
| 22 | 127.35 | 58.62 | 0.46 |

When the cross-section in the first and third directions was observed from the center of Samples 13 to 22 in the second direction, no samples with cracks or delamination were found.

From this, it can be seen that, when 0.37≤w2/w1≤0.53 is satisfied, the bonding force between the capacitance formation portion and the side margin portion is improved, thereby improving the strength characteristics.

One of the several problems to be solved by the present disclosure is to prevent cracks or delamination inside a multilayer electronic component.

One of the various problems to be solved by the present disclosure is to improve the reliability of a multilayer electronic component.

While example exemplary embodiments have been shown and described above, it will be apparent to those skilled in the art that modifications and variations could be made without departing from the scope of the present disclosure as defined by the appended claims.

What is claimed is:

1. A multilayer electronic component comprising:
a body including a dielectric layer and internal electrodes; and
external electrodes arranged on the body,
wherein at least one of the internal electrodes includes an oxidized portion arranged at both end portions of the at least one of the internal electrodes in a width direction, and a non-oxidized portion arranged in a center of the at least one of the internal electrodes in the width direction,
wherein t2<t1, in which t1 is an average thickness of the non-oxidized portion and t2 is an average thickness of the oxidized portion.

2. The multilayer electronic component of claim 1, wherein the oxidized portion and non-oxidized portion are arranged to be in contact with each other.

3. The multilayer electronic component of claim 2, wherein, in a region in which the oxidized portion and the non-oxidized portion are in contact with each other, a thickness of the non-oxidized portion is greater than a thickness of the oxidized portion.

4. The multilayer electronic component of claim 1, wherein t1 and t2 satisfy 0.05≤t2/t1≤0.65.

5. The multilayer electronic component of claim 1, wherein t1 is 2.0 μm or less.

6. The multilayer electronic component of claim 1, wherein t2 is 1.0 μm or less.

7. The multilayer electronic component of claim 1, wherein w2<w1, in which w1 is an average width from one end portion of the non-oxidized portion in the width direction to an adjacent widthwise surface of the body and w2 is an average width of the oxidized portion disposed at one of the both end portions in the width direction.

8. The multilayer electronic component of claim 7, wherein w1 and w2 satisfy 0.3≤w2/w1≤0.6.

9. The multilayer electronic component of claim 7, wherein w1 is 150 μm or less.

10. The multilayer electronic component of claim 7, wherein w2 is 40 μm or more and 80 μm or less.

11. The multilayer electronic component of claim 1, wherein the oxidized portion is disposed to be spaced apart from a widthwise surface of the body.

12. The multilayer electronic component of claim 1, wherein the oxidized portion is not substantially bent.

13. The multilayer electronic component of claim 1, wherein a length of the multilayer electronic component is 0.6 mm or less, and a width of the multilayer electronic component is 0.3 mm or less.

14. A method of manufacturing the multilayer electronic component of claim 1, the method comprising:
forming a first internal electrode pattern having a first width on a ceramic green sheet, and
forming a second internal electrode pattern having a second width on the first internal electrode pattern,
wherein the second width is smaller than the first width.

15. The method claim 14, further comprising:
stacking and pressing a plurality of the ceramic green sheet on which the first internal electrode pattern and the second internal electrode pattern are formed to form a stack, and
sintering the stack.

16. The method claim 15, wherein the sintering of the stack includes oxidizing a widthwise end portion of the first internal electrode pattern to form the oxidized portion.
